(19) United States
(12) Patent Application Publication
(10) Pub. No.: US 2022/0155009 A1
(43) Pub. Date: May 19, 2022

(54) METHODS AND APPARATUSES FOR PRODUCING SOLID DRY MANURE

(71) Applicant: The Regents of the University of California, Oakland, CA (US)

(72) Inventor: Pramod Pandey, Davis, CA (US)

(21) Appl. No.: 17/441,575

(22) PCT Filed: Apr. 1, 2020
(86) PCT No.: PCT/US2020/026172

§ 371 Date: Sep. 21, 2021

Related U.S. Application Data
(60) Provisional application No. 62/926,198, filed on Oct. 25, 2019.
(60) Provisional application No. 62/828,314, filed on Apr. 2, 2019.

(51) Int. Cl. F26B 3/347; C02F 11/131

(52) U.S. Cl. CPC F26B 3/347; F26B 2200/12; C02F 11/131

(57) ABSTRACT

Aspects of the present disclosure include methods of producing solid dry manure. In certain embodiments, the methods comprise disposing solid manure on a first conveyor operably coupled to a microwave radiation source. Such methods further comprise, using the first conveyor, conveying the solid manure past the microwave radiation source, and during the conveying, exposing the solid manure to microwave radiation emitted from the microwave radiation source to produce solid dry manure. Also provided are apparatuses that find use, e.g., in practicing the methods of the present disclosure.

### CROSS-REFERENCE TO RELATED APPLICATIONS

This application claims the benefit of U.S. Provisional Patent Application No. 62/926,198, filed Oct. 25, 2019, and U.S. Provisional Patent Application No. 62/828,314, filed Apr. 2, 2019, which applications are incorporated herein by reference in their entirety

### INTRODUCTION

Conventionally, manure is flushed from a barn (e.g., a dairy barn) and pumped from a manure pit to a solid manure separator for separating solid and liquid of flushed manure. The solid fraction is open sun-dried for months, and liquid fractions are stored for multiple months in lagoons. One of the major challenges associated with solid fractions of manure is that it contains more than 85-90% moisture, and the high level of moisture in manure is linked with greenhouse gas emissions. Another issue, which prohibits the use of manure as soil amendment for crop production is the risk of manure borne bacteria, some of which are pathogenic to humans.

Conventional approaches for reducing moisture and controlling pathogens in manure include open solar drying, closed solar drying, natural gas-fueled dryers, solid storage, composting in aerated piles, composting in passive windrows, composting in intensive windrows, in-vessel composting, and forced evaporation. These methods require days, weeks and months to substantially reduce the moisture and pathogens. Further, due to the substantial weight of wet manure, excessive cost is required for handling, transporting, and treating the manure. Nonetheless, these approaches are common because a robust technology which can be implemented in a farm environment does not exist. The methods and apparatuses of the present disclosure address the aforementioned shortcomings of the current approaches.

### SUMMARY

Aspects of the present disclosure include methods of producing solid dry manure. In certain embodiments, the methods comprise disposing solid manure on a first conveyor operably coupled to a microwave radiation source. Such methods further comprise, using the first conveyor, conveying the solid manure past the microwave radiation source, and during the conveying, exposing the solid manure to microwave radiation emitted from the microwave radiation source to produce solid dry manure. Also provided are apparatuses that find use, e.g., in practicing the methods of the present disclosure.

### BRIEF DESCRIPTION OF THE FIGURES

FIG. 1 provides a schematic depiction of the process of producing solid dry manure from flush manure, generated in places such as dairy barns, using a conveyor operably coupled to an infrared radiation source and a microwave radiation source. Solid manure is generated from flush manure by collecting it in a manure pit and running it through a solid manure separator. Using a conveyor, the solid manure is conveyed via a hopper and feeder past an infrared radiation source and a microwave radiation source, exposing the solid manure to infrared and microwave radiation emitted from the infrared and microwave radiation sources during the conveying, to produce solid dry manure. The solid dry manure is collected using a feeder and conveyor.

FIG. 2 provides a depiction of a dairy barn, where flush manure is generated.

FIG. 3 provides a depiction of a manure pit, where the flush manure is collected.

FIG. 4 provides a depiction of a manure solid manure separator used to generate solid manure from flush manure.

FIG. 5 provides a depiction of a solid manure separator conveyor used for conveying the solid manure through a hopper with feeder.

FIG. 6 provides a depiction of a solid manure separator conveyor (belt #1) used for conveying the solid manure from separator to integrated hopper and screw feeder.

FIG. 7 provides a depiction of a hopper with screw feeder via which the solid manure is fed into a conveyor operably linked to an infrared radiation source and a microwave radiation source.

FIG. 8 provides a depiction of a conveyor operably linked to an infrared radiation source and a microwave radiation source, in which solid manure is exposed to infrared and microwave radiation emitted from the infrared and microwave radiation sources during the conveying.

FIG. 9 provides a depiction of conveyor belt, which passes through infrared and microwave system.

FIG. 10 provides a depiction of a conveyor used for collecting the solid dry manure that has been exposed to infrared and microwave radiation.

FIG. 11 shows the reduction in moisture weight and total manure weight of the solid manure after being irradiated with microwave radiation. The solid dry manure shows over 80% reduction in moisture weight and total manure weight after being exposed to microwave radiation for 10 minutes.

FIG. 12 shows drying rate and drying time using 1.250 kw microwave system in batch mode.

FIG. 13 shows relationships between belt speed (feet/min) and belt length exposed to microwave heat at 1.250 kw.

FIG. 14 shows temperature profile of manure (coming out of solid separator) using 1.650 kw microwave system in batch mode.

FIG. 15 is a graph of temperature of solid manure of various average thickness over time during exposure to microwave treatment.

FIG. 16 panels A-D are graphs showing pathogen content over time in the manure treated in the study shown in FIG. 15.

FIG. 17 panels A-D are graphs showing moisture content over time in the manure treated in the study shown in FIG. 15.

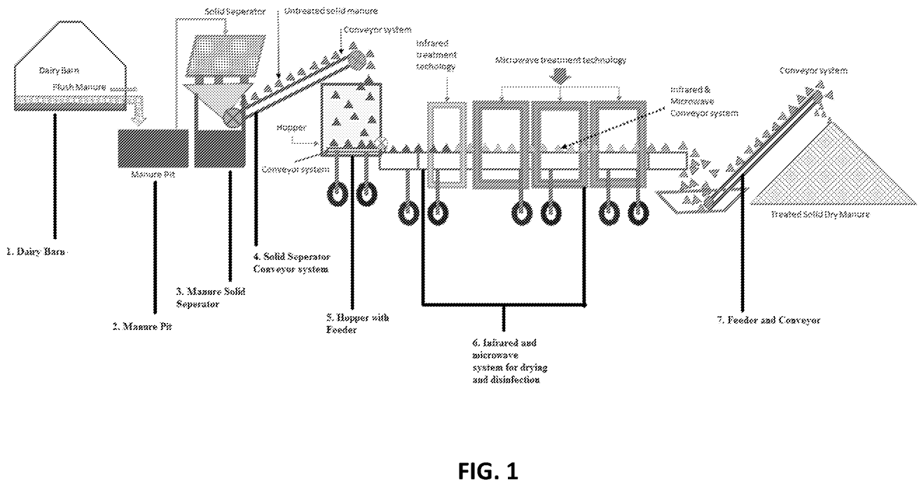

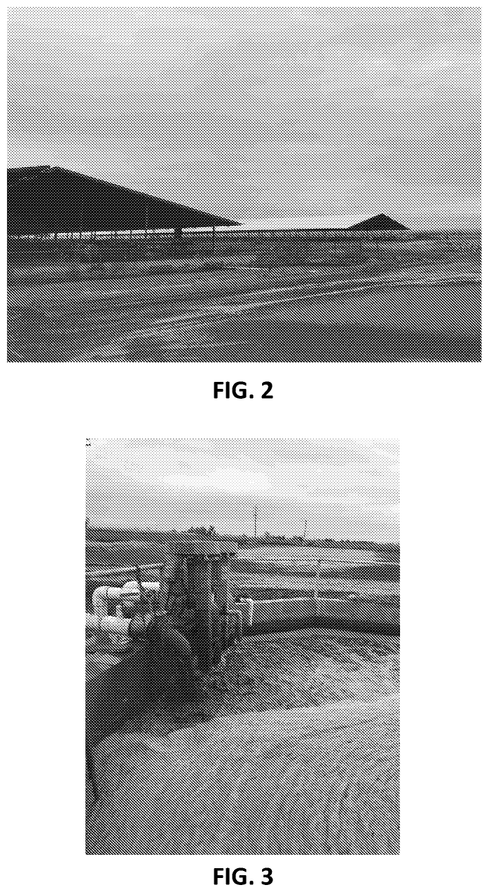

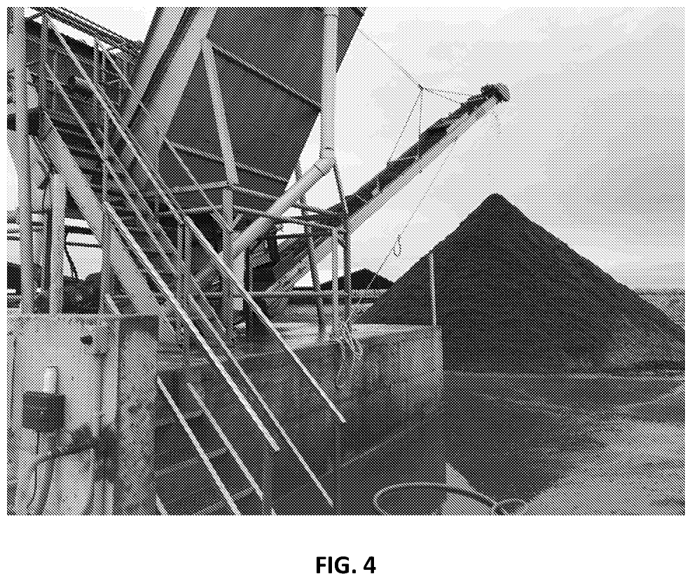

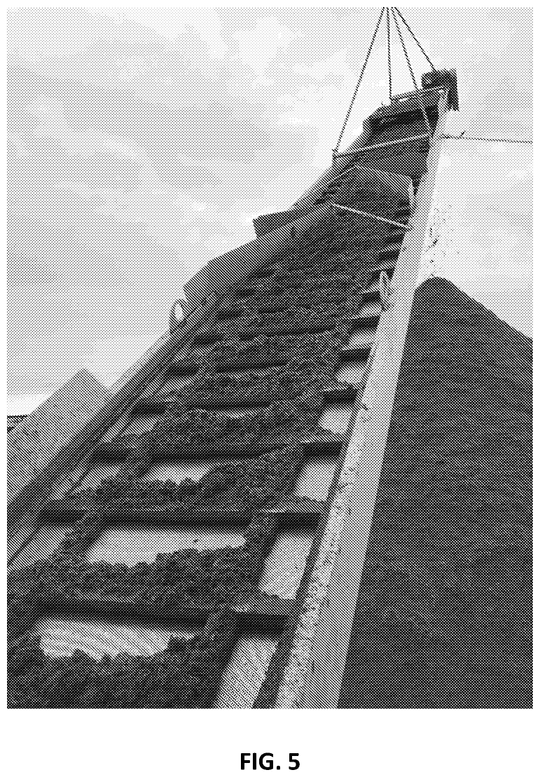

### DETAILED DESCRIPTION

Before the methods and apparatuses of the present disclosure are described in greater detail, it is to be understood that the methods and apparatuses are not limited to particular embodiments described, as such may, of course, vary. It is also to be understood that the terminology used herein is for the purpose of describing particular embodiments only, and is not intended to be limiting, since the scope of the methods and apparatuses will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the methods and apparatuses. The upper and lower limits of these smaller ranges may independently be included in the smaller ranges and are also encompassed within the methods and apparatuses, subject to any specifically excluded limit in the stated range. Where the stated range includes one or both of the limits, ranges excluding either or both of those included limits are also included in the methods and apparatuses.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which the methods and apparatuses belong. Although any methods and apparatuses similar or equivalent to those described herein can also be used in the practice or testing of the methods and apparatuses, representative illustrative methods and apparatuses are now described.

All publications and patents cited in this specification are herein incorporated by reference as if each individual publication or patent were specifically and individually indicated to be incorporated by reference and are incorporated herein by reference to disclose and describe the materials and/or methods in connection with which the publications are cited. The citation of any publication is for its disclosure prior to the filing date and should not be construed as an admission that the present methods and apparatuses are not entitled to antedate such publication, as the date of publication provided may be different from the actual publication date which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

It is appreciated that certain features of the methods and apparatuses, which are, for clarity, described in the context of separate embodiments, may also be provided in combination in a single embodiment. Conversely, various features of the methods and apparatuses, which are, for brevity, described in the context of a single embodiment, may also be provided separately or in any suitable sub-combination. All combinations of the embodiments are specifically embraced by the present disclosure and are disclosed herein just as if each and every combination was individually and explicitly disclosed, to the extent that such combinations embrace operable processes and/or compositions. In addition, all sub-combinations listed in the embodiments describing such variables are also specifically embraced by the present methods and apparatuses and are disclosed herein just as if each and every such sub-combination was individually and explicitly disclosed herein.

As will be apparent to those of skill in the art upon reading this disclosure, each of the individual embodiments described and illustrated herein has discrete components and features which may be readily separated from or combined with the features of any of the other several embodiments without departing from the scope or spirit of the present methods. Any recited method can be carried out in the order of events recited or in any other order that is logically possible.

### Methods

The present disclosure provides methods for producing solid dry manure. The methods include disposing solid manure on a first conveyor operably coupled to a microwave radiation source and during the conveying, exposing the solid manure to microwave radiation emitted from the microwave radiation source to produce solid dry manure. In one aspect, the conveying is continuous. In another aspect, the conveying is discontinuous. Solid manure and/or flush manure may be obtained from agricultural operations, non-limiting examples of which include cattle farm or dairy barn, pig farm, chicken, turkey, duck or other poultry barn, horse stable, sheep or goat farm, from a zoo, or other source of large quantities of manure.

In certain embodiments, the methods include separating the solid manure from flushed manure prior to disposing the solid manure on the first conveyor. As used herein, “flushed manure” is the manure generated after manure from a dairy barn (e.g., free stall) is flushed using water, e.g., recycled manure water from one or more lagoons. This manure has high total solids (TS) and volatile solids (VS). The TS is the weight of dried manure residue at 104 deg C. for 12 hours. Volatile solids are the organic matter, which are lost on ignition of the dry solid at 550 deg C. for 2-4 hours. As used herein, “solid manure” is the solid manure component obtained after flushed manure passes through a solid-liquid manure separator (sometimes referred to herein as a “solid manure separator”, a “manure solid separator” or a “solid separator”). In certain embodiments, the solid manure has a moisture content of from 65% to 85%, such as from 70% to 80%, e.g., about 75%. It is the solid manure that is disposed on the first conveyor operably coupled to a microwave radiation source to be treated using the microwave radiation source. As used herein, “liquid manure” is the liquid manure component obtained after flushed manure passes through a solid-liquid manure separator. This liquid manure has a low solid content compared to the solid content of flushed manure. Liquid manure may go to lagoons without microwave treatment, and recycled to flush the freestall/dairy barn.

Accordingly, the solid manure is obtained from flush manure using a solid manure separator. According to some embodiments, the solid manure separator is operably coupled to the first conveyor. In certain embodiments, the methods include collecting flush manure in a manure pit prior to subjecting flush manure to a solid manure separator. The solid manure separator may be operably coupled to the first conveyor via a second conveyor. According to some embodiments, the methods include disposing the solid manure in a hopper operably coupled to the first conveyor using a second conveyor. Solid manure separators are known in the art, non-limiting examples of which are provided in U.S. Pat. No. 4,666,602 and U.S. Application Nos. 20060243677 and 20060273048.

In certain embodiments, the conveying is continuous. In another aspect, the conveying is discontinuous. The thickness of the solid manure on the conveyors can be from about 0.25 inches to about 0.5 inches, or alternatively from about 0.5 inches to about 0.75 inches, or alternatively from about 0.75 inches to about 1 inch, or alternatively from about 1 inch to about 1.25 inches, or alternatively from about 1.25 inches to about 1.5 inches, or alternatively from about 1.5 inches to about 1.75 inches, or alternatively from about 1.75 inches to about 2 inches, or alternatively from about 2 inch to about 2.25 inches, or alternatively from about 2.25 inches to about 2.5 inches, or alternatively from about 2.5 inches to about 2.75 inches, or alternatively from about 2.75 inches to about 3 inches, or alternatively from about 3 inch to about 3.25 inches, or alternatively from about 3.25 inches to about 3.5 inches, or alternatively from about 3.5 inches to about 3.75 inches, or alternatively from about 3.75 inches to about 4 inches. In some embodiments, the thickness of the solid manure on the conveyors is from about 0.5 to about 5 inches, e.g., from about 0.75 inches to about 4 inches, or from about 1 inch to 3 inches, such as about 2 inches.

According to some embodiments, the average thickness of the solid manure on the first conveyor is from about 5 cm to about 100 cm. For example, the average thickness of the solid manure on the first conveyor may be from about 10 cm to about 70 cm. In certain embodiments, the average thickness of the solid manure on the first conveyor is from about 5 cm to about 15 cm, from about 30 cm to about 40 cm, from about 50 cm to about 60 cm, or from about 65 cm to about 75 cm. According to any of the preceding average thicknesses, the solid manure may be exposed to the microwave radiation (e.g., using an about 1500 watt to about 1700 watt, e.g., about 1600 watt, microwave source, e.g., at 120 V and 60 Hz) for a duration of 12 minutes or less, e.g., for about 6 to about 12 minutes, such as from about 7 to about 11 minutes, e.g., from about 8 to about 10 minutes. In certain embodiments, during such exposure, the pathogen content (e.g., E. coli content) in the solid manure is 20% or less, 10% or less, 5% or less, 2.5% or less, or 0% as compared to the pathogen content (e.g., E. coli content) in the solid manure prior to exposure to the microwave radiation. According to some embodiments, during such exposure, the moisture content is 50% or less, 45% or less (e.g., about 35% to about 45%), or 40% or less (e.g., about 35% to about 40%), as compared to the moisture content in the solid manure prior to exposure to the microwave radiation—such that solid dry manure is produced as a result of the exposure to the microwave radiation. In certain embodiments, the duration of exposure of the solid manure to the microwave radiation is determined based on a selected speed of the first conveyor.

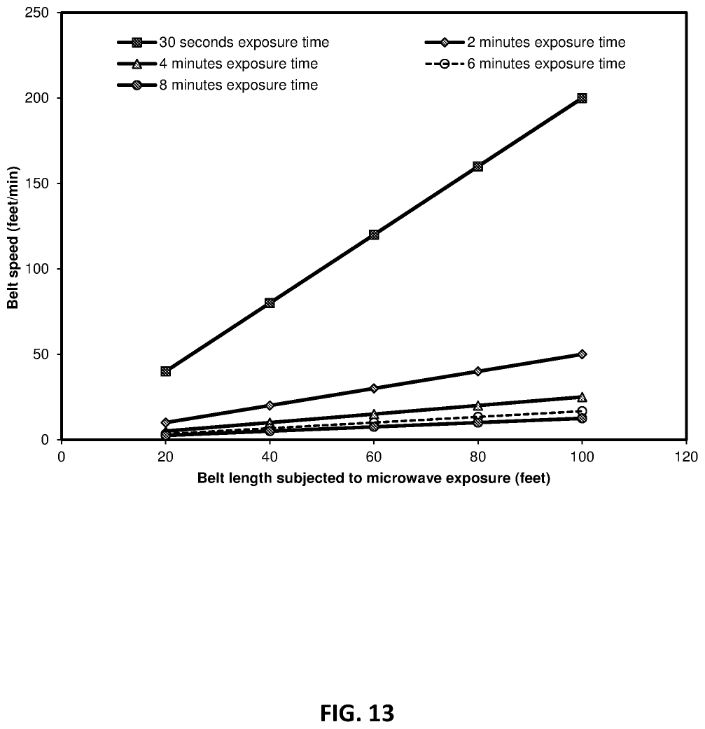

In some embodiments, the speed of the manure on the first conveyor during its exposure to microwave and/or infrared radiation is from about 50 to about 200 feet per minute, or alternatively from about 20 to about 30 feet per minute, or alternatively from about 30 to about 40 feet per minute, or alternatively from about 40 to about 50 feet per minute, or alternatively from about 50 to about 60 feet per minute, or alternatively from about 60 to about 70 feet per minute, or alternatively from about 70 to about 80 feet per minute, or alternatively from about 80 to about 90 feet per minute, or alternatively from about 90 to about 100 feet per minute, or alternatively from about 100 to about 110 feet per minute, or alternatively from about 110 to about 120 feet per minute, or alternatively from about 120 to about 130 feet per minute, or alternatively from about 130 to about 140 feet per minute, or alternatively from about 140 to about 150 feet per minute, or alternatively from about 150 to about 160 feet per minute, or alternatively from about 160 to about 170 feet per minute, or alternatively from about 170 to about 180 feet per minute, or alternatively from about 180 to about 190 feet per minute, or alternatively from about 190 to about 200 feet per minute, or alternatively from about 200 to about 210 feet per minute, or alternatively from about 210 to about 220 feet per minute, or alternatively from about 220 to about 230 feet per minute, or alternatively from about 230 to about 240 feet per minute, or alternatively from about 240 to about 250 feet per minute. In certain embodiments, the speed of the manure on the conveyors during their exposure to microwave or infrared radiation is the belt speed shown in FIG. 13.

Conveyors that may be employed when practicing the methods of the present disclosure are known. Non-limiting examples of conveyors that can be used include roller-belt conveyor such as those described in U.S. Pat. No. 7,249,671, accumulator conveyors such as those described in U.S. Pat. No. 7,063,206, and loading conveyors such as those described in U.S. Pat. No. 2,721,645. Roller-belt conveyors use a roller belt with rollers arranged to rotate on oblique axes to urge articles toward a side guide. The roller-belt conveyor includes an oblique-roller belt supported on a carry way for running in a direction of belt travel. Each roller rotates on an axis oblique to the direction of belt travel and intersects the side guide downstream of the roller's position. The rotating rollers provide a component of force to the blocked articles directed toward the side guide to push the articles against the side guide or other articles as they accumulate under low pressure upstream of the stop. Loading conveyors are used to deliver articles from loading platform on to the bed of a truck. Loading conveyors can be adjusted in position on the loading platform and adjustable as to height to service trucks with beds of differing heights, and are also adjustable as to length so that articles may be discharged in any desired area of the truck bed without having the conveyor itself necessarily supported from such bed. Accumulator conveyors accommodate uneven throughput of articles in the system. When the rate of input of articles to the conveyor lines may be uneven it could be desirable to use an accumulator conveyor to provide accumulation of articles along the conveyor lines. In certain embodiments, the conveyor lines may supply a merge assembly to combine the outputs of the conveyor lines prior to supplying articles to the downstream process.

Further non-limiting examples of conveyors that may be used include singulating conveyors such as those described in U.S. Pat. No. 6,758,323, and feed conveyors such as those described in U.S. Pat. Nos. 4,715,593 and 5,234,094. The singulating conveyor includes a first centering conveying zone in which one or more roller-top conveyor mats direct conveyed articles sidewise toward a side or the center of the zone. The rollers on which the articles ride rotate about axes oblique to the conveying direction to provide a sidewise component of motion to the articles. A feed conveyor system is used for bottom feeding from a stack of articles, said system operative to lower the stack onto a conveyor portion which begins to strip an item from the bottom of the stack and positions it to a metering device for individual withdrawal and to a further pullout device whereupon the stock is lifted by a slidable lifter which allows the remainder of the bottom item to be completely withdrawn by the pullout device while the higher up items are held out of reach of the metering device.

Agricultural conveyors may also be used. Non-limiting examples of agricultural conveyors are provided in U.S. Pat. Nos. 10,375,889, 5,722,888 and 4,653,632, and U.S. Application No. 20190152714. In some embodiments, the conveyors include a self-propelled chassis, wherein the front end of the conveyor is configured to be raised and lowered automatically.

Further non-limiting examples of conveyors that can be used include screw conveyors. Non-limiting examples of screw conveyors are provided in U.S. Pat. Nos. 3,212,624 and 6,035,546, which describes a screw conveyor with infrared heat radiators in a tempering zone for thermal treatment of bulk materials.

It is generally known that microwaves are a form of electromagnetic radiation of wavelengths ranging from about one meter to one millimeter and frequencies of from about 300 MHz to about 300 GHz. In certain embodiments, exposing the solid manure to the microwave radiation produces solid dry manure having a moisture weight that is reduced by 50% or more as compared to the solid manure. In some embodiments, exposing the solid manure to the microwave radiation produces solid dry manure having a moisture weight that is reduced by about 75% or more as compared to the solid manure. According to some embodiments, exposing the solid manure to the microwave radiation produces solid dry manure having a moisture weight that is reduced by from about 20% to about 25%, or alternatively from about 25% to about 30%, or alternatively from about 30% to about 35%, or alternatively from about 35% to about 40%, or alternatively from about 40% to about 45%, or alternatively from about 45% to about 50%, or alternatively from about 50% to about 55%, or alternatively from about 55% to about 60%, or alternatively from about 60% to about 65%, or alternatively from about 65% to about 70%, or alternatively from about 70% to about 75%, or alternatively from about 75% to about 80%, or alternatively from about 80% to about 82%, or alternatively from about 82% to about 84%, or alternatively from about 84% to about 86%, or alternatively from about 86% to about 88%, or alternatively from about 88% to about 90%, or alternatively from about 90% to about 92%, or alternatively from about 92% to about 94%, or alternatively from about 94% to about 96%, or alternatively from about 96% to about 98%, or alternatively from about 98% to about 99%.

In certain embodiments, exposing the solid manure to the microwave radiation produces solid dry manure having total weight that is reduced by 50% or more as compared to the solid manure. In some embodiments, exposing the solid manure to the microwave radiation produces solid dry manure having total weight that is reduced by about 75% or more as compared to the solid manure. In specific embodiments, exposing the solid manure to the microwave radiation produces solid dry manure having total weight that is reduced by from about 20% to about 25%, or alternatively from about 25% to about 30%, or alternatively from about 30% to about 35%, or alternatively from about 35% to about 40%, or alternatively from about 40% to about 45%, or alternatively from about 45% to about 50%, or alternatively from about 50% to about 55%, or alternatively from about 55% to about 60%, or alternatively from about 60% to about 65%, or alternatively from about 65% to about 70%, or alternatively from about 70% to about 75%, or alternatively from about 75% to about 80%, or alternatively from about 80% to about 82%, or alternatively from about 82% to about 84%, or alternatively from about 84% to about 86%, or alternatively from about 86% to about 88%, or alternatively from about 88% to about 90%, or alternatively from about 90% to about 92%, or alternatively from about 92% to about 94%, or alternatively from about 94% to about 96%, or alternatively from about 96% to about 98%, or alternatively from about 98% to about 99%.

According to some embodiments, the microwave radiation emitted from the microwave radiation source is from about 1.2 kW to about 75 kW, or alternatively from about 0.25 kW to about 0.5 kW, or alternatively from about 0.5 kW to about 1 kW, or alternatively from about 1 kW to about 1.2 kW, or alternatively from about 1.2 kW to about 1.5 kW, or alternatively from about 1.5 kW to about 2 kW, or alternatively from about 2 kW to about 2.5 kW, or alternatively from about 2.5 kW to about 5 kW, or alternatively from about 5 kW to about 10 kW, or alternatively from about 10 kW to about 20 kW, or alternatively from about 20 kW to about 25 kW, or alternatively from about 25 kW to about 35 kW, or alternatively from about 35 kW to about 45 kW, or alternatively from about 45 kW to about 55 kW, or alternatively from about 55 kW to about 65 kW, or alternatively from about 65 kW to about 75 kW, or alternatively from about 75 kW to about 85 kW, or alternatively from about 85 kW to about 95 kW, or alternatively from about 95 kW to about 105 kW, or alternatively from about 105 kW to about 115 kW, or alternatively from about 115 kW to about 125 kW. In certain embodiments, the microwave radiation exposure is about 75 kW. The microwave radiation exposure can be for about 0.5 minutes to about 10 minutes, alternatively from about 0.1 minutes to about 0.25 minutes, alternatively from about 0.25 minutes to about 0.5 minutes, alternatively from about 0.5 minutes to about 0.75 minutes, alternatively from about 0.75 minutes to about 1 minutes, alternatively from about 1 minutes to about 1.5 minutes, alternatively from about 1.5 minutes to about 2 minutes, alternatively from about 2 minutes to about 2.5 minutes, alternatively from about 2.5 minutes to about 3 minutes, alternatively from about 3 minutes to about 6 minutes, or alternatively from about 1 minute to about 2 minutes, or alternatively from about 2 minutes to about 3 minutes, or alternatively from about 3 minutes to about 4 minutes, or alternatively from about 4 minutes to about 5 minutes, or alternatively from about 5 minutes to about 6 minutes, or alternatively from about 6 minutes to about 9 minutes, or alternatively from about 9 minutes to about 12 minutes, or alternatively from about 12 minutes to about 15 minutes, or alternatively from about 15 minutes to about 18 minutes, or alternatively from about 18 minutes to about 21 minutes, or alternatively from about 21 minutes to about 24 minutes. In a specific embodiment, the microwave radiation exposure is for about 6 minutes. In one particular embodiment, the microwave radiation exposure is about 75 kW for about 6 minutes.

In certain embodiments, the temperature of the solid manure after microwave treatment is from about 50° C. to about 60° C., or alternatively about 60° C. to about 70° C., or alternatively from about 70° C. to about 80° C., or alternatively from about 80° C. to about 90° C., or alternatively from about 90° C. to about 100° C., or alternatively from about 100° C. to about 110° C., or alternatively from about 110° C. to about 120° C., or alternatively from about 120° C. to about 130° C., or alternatively from about 130° C. to about 140° C., or alternatively from about 140° C. to about 150° C.

In some embodiments, the methods include using the first conveyor, conveying the solid manure past the infrared radiation source; and during the conveying, exposing the solid manure to infrared radiation emitted from the infrared radiation source. In one aspect, the first conveyor is further operably coupled to an infrared radiation source. In certain embodiments, the solid manure is exposed to the infrared radiation prior to the solid manure being exposed to the microwave radiation. In other embodiments, the methods include exposing the solid manure to the microwave radiation to produce the solid dry manure, and subsequently exposing the solid dry manure to the infrared radiation. The solid dry manure may be collected using a feeder and conveyor system as described above.

It is generally known that infrared radiation (IR) is an electromagnetic radiation (EMR) with wavelengths from about 700 nanometers (frequency 430 THz), to 1 millimeter (300 GHz). The IR radiation exposure can be from about 30,000 to about 150,000 BTUH, or alternatively from about 10,000 to about 20,000 BTUH, or alternatively from about 20,000 to about 30,000 BTUH, or alternatively from about 30,000 to about 40,000 BTUH, or alternatively from about 40,000 to about 50,000 BTUH, or alternatively from about 50,000 to about 60,000 BTUH, or alternatively from about 60,000 to about 70,000 BTUH, or alternatively from about 70,000 to about 80,000 BTUH, or alternatively from about 80,000 to about 90,000 BTUH, or alternatively from about 90,000 to about 100,000 BTUH, or alternatively from about 100,000 to about 110,000 BTUH, or alternatively from 110,000 to about 120,000 BTUH, or alternatively from about 120,000 to about 130,000 BTUH, or alternatively from about 130,000 to about 140,000 BTUH, or alternatively from about 140,000 to about 150,000 BTUH, or alternatively from about 150,000 to about 160,000 BTUH, or alternatively from about 160,000 to about 170,000 BTUH, or alternatively from about 170,000 to about 180,000 BTUH, or alternatively from about 180,000 to about 190,000 BTUH, or alternatively from about 190,000 to about 200,000 BTUH. The IR radiation exposure can be from about 0.5 minutes to about 3 minutes, or alternatively from about 0.5 minutes to about 10 minutes, alternatively from about 0.1 minutes to about 0.25 minutes, alternatively from about 0.25 minutes to about 0.5 minutes, alternatively from about 0.5 minutes to about 0.75 minutes, alternatively from about 0.75 minutes to about 1 minutes, alternatively from about 1 minutes to about 1.5 minutes, alternatively from about 1.5 minutes to about 2 minutes, alternatively from about 2 minutes to about 2.5 minutes, alternatively from about 2.5 minutes to about 3 minutes, alternatively from about 3 minutes to about 6 minutes, or alternatively from about 1 minute to about 2 minutes, or alternatively from about 2 minutes to about 3 minutes, or alternatively from about 3 minutes to about 4 minutes, or alternatively from about 4 minutes to about 5 minutes, or alternatively from about 5 minutes to about 6 minutes, or alternatively from about 6 minutes to about 9 minutes, or alternatively from about 9 minutes to about 12 minutes, or alternatively from about 12 minutes to about 15 minutes, or alternatively from about 15 minutes to about 18 minutes, or alternatively from about 18 minutes to about 21 minutes, or alternatively from about 21 minutes to about 24 minutes.

In certain embodiments, the temperature of the solid manure after infrared treatment is from about 50° C. to about 60° C., or alternatively about 60° C. to about 70° C., or alternatively from about 70° C. to about 80° C., or alternatively from about 80° C. to about 90° C., or alternatively from about 90° C. to about 100° C., or alternatively from about 100° C. to about 110° C., or alternatively from about 110° C. to about 120° C., or alternatively from about 120° C. to about 130° C., or alternatively from about 130° C. to about 140° C., or alternatively from about 140° C. to about 150° C.

In certain embodiments, exposing the solid manure to the infrared radiation produces solid manure having a viable pathogen content that is reduced by about 75% or more as compared to the solid manure prior to exposure to the infrared radiation. In specific embodiments, exposing the solid manure to the infrared radiation produces solid manure having a viable pathogen content that is reduced by about 95% or more as compared to the solid manure prior to exposure to the infrared radiation. According to some embodiments, the infrared radiation produces solid manure having a viable pathogen content that is reduced from about 20% to about 25%, or alternatively from about 25% to about 30%, or alternatively from about 30% to about 35%, or alternatively from about 35% to about 40%, or alternatively from about 40% to about 45%, or alternatively from about 45% to about 50%, or alternatively from about 50% to about 55%, or alternatively from about 55% to about 60%, or alternatively from about 60% to about 65%, or alternatively from about 65% to about 70%, or alternatively from about 70% to about 75%, or alternatively from about 75% to about 80%, or alternatively from about 80% to about 82%, or alternatively from about 82% to about 84%, or alternatively from about 84% to about 86%, or alternatively from about 86% to about 88%, or alternatively from about 88% to about 90%, or alternatively from about 90% to about 92%, or alternatively from about 92% to about 94%, or alternatively from about 94% to about 96%, or alternatively from about 96% to about 98%, or alternatively from about 98% to about 99%.

### Apparatuses

As summarized above, the present disclosure also provides apparatuses for producing solid dry manure. Provided herein are apparatuses for producing solid dry manure that include a solid manure separator operably coupled to a first conveyor; and a microwave radiation source operably coupled to the first conveyor. Solid manure separators are known in the art, non-limiting examples of which are provided in U.S. Pat. No. 4,666,602 and U.S. Application Nos. 20060243677 and 20060273048.

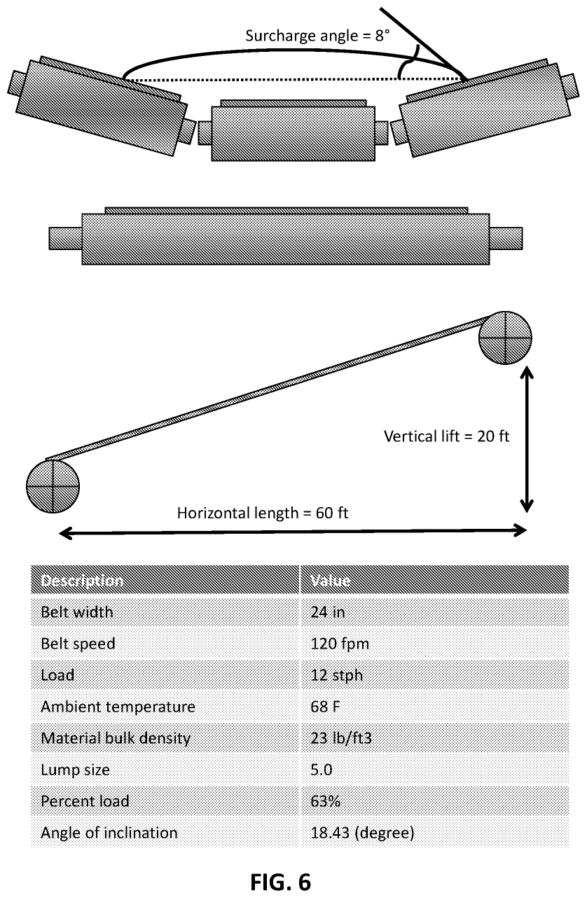

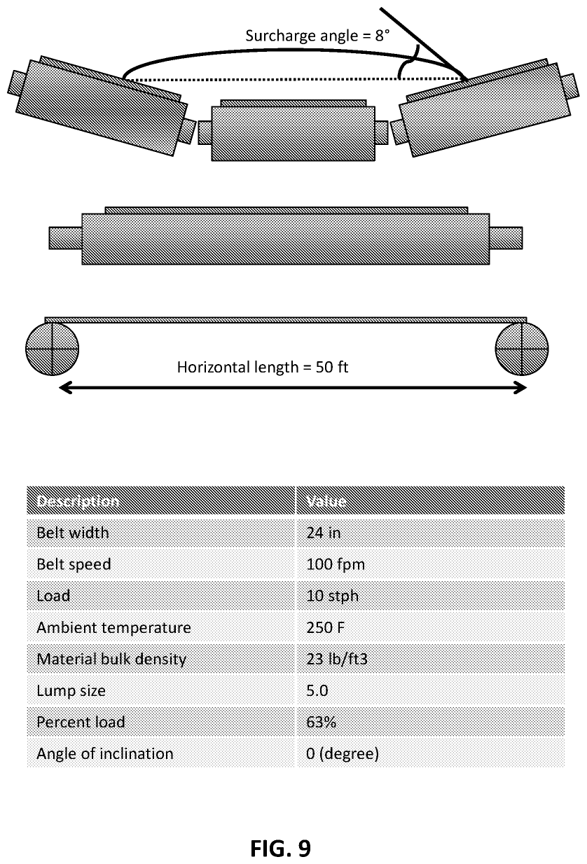

In one aspect, the apparatuses include a solid manure separator operably coupled to the first conveyor via a second conveyor. In another aspect, the first conveyor is operably coupled to a hopper, and the second conveyor is configured to dispose solid manure into the hopper. FIG. 9 describes a particular embodiment of the first conveyor and provides examples of approximate surcharge angle, belt width, belt speed, load, ambient temperature, material bulk density, lump size, percent load and angle of inclination. FIG. 6 describes a specific embodiment of the second conveyor for conveying the solid manure from separator to integrated hopper and screw feeder and provides examples of approximate surcharge angle, belt width, belt speed, load, ambient temperature, material bulk density, lump size, percent load and angle of inclination.

In some embodiments, the second conveyer is inclined such that the inclined end of the second conveyor is disposed above the hopper. In certain embodiments, the second conveyer is inclined at an angle from about 5 to about 10 degrees, or alternatively from about 10 to about 15 degrees, or alternatively from about 15 to about 18 degrees, or alternatively from about 18 to about 20 degrees, or alternatively from about 20 to about 25 degrees, or alternatively from about 25 to about 30 degrees, or alternatively from about 30 to about 35 degrees, or alternatively from about 35 to about 40 degrees, or alternatively from about 40 to about 45 degrees, or alternatively from about 45 to about 50 degrees. In one specific embodiment, the second conveyer is inclined at an angle of about 18.43 degrees.

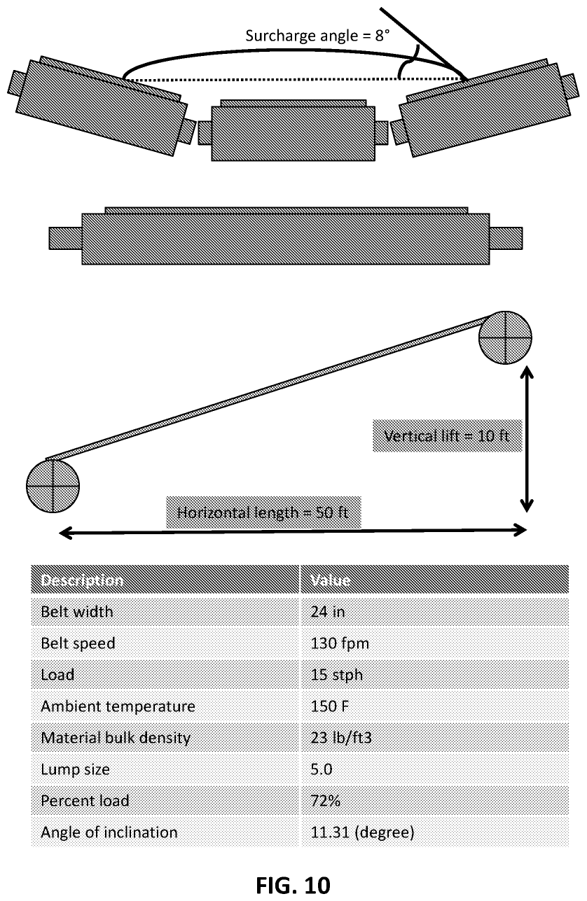

Further, provided herein are apparatuses wherein the first conveyor is operably coupled to a third conveyor. In certain embodiments, the third conveyor is inclined, the lower portion of the third conveyor is operably coupled to a feeder, and the first conveyor is configured to dispose solid dry manure produced using the microwave radiation source into the feeder. In some embodiments, the third conveyer is inclined at an angle from about 5 to about 7.5 degrees, or alternatively from about 7.5 to about 10 degrees, or alternatively from about 10 to about 11 degrees, or alternatively from about 11 to about 12 degrees, or alternatively from about 12 to about 15 degrees, or alternatively from about 10 to about 15 degrees, or alternatively from about 15 to about 18 degrees, or alternatively from about 18 to about 20 degrees, or alternatively from about 20 to about 25 degrees, or alternatively from about 25 to about 30 degrees, or alternatively from about 30 to about 35 degrees, or alternatively from about 35 to about 40 degrees, or alternatively from about 40 to about 45 degrees, or alternatively from about 45 to about 50 degrees. In one specific embodiment, the third conveyer is inclined at an angle of about 11.31 degrees. FIG. 10 describes a particular embodiment of the third conveyor and provides examples of approximate surcharge angle, belt width, belt speed, load, ambient temperature, material bulk density, lump size, percent load and angle of inclination.

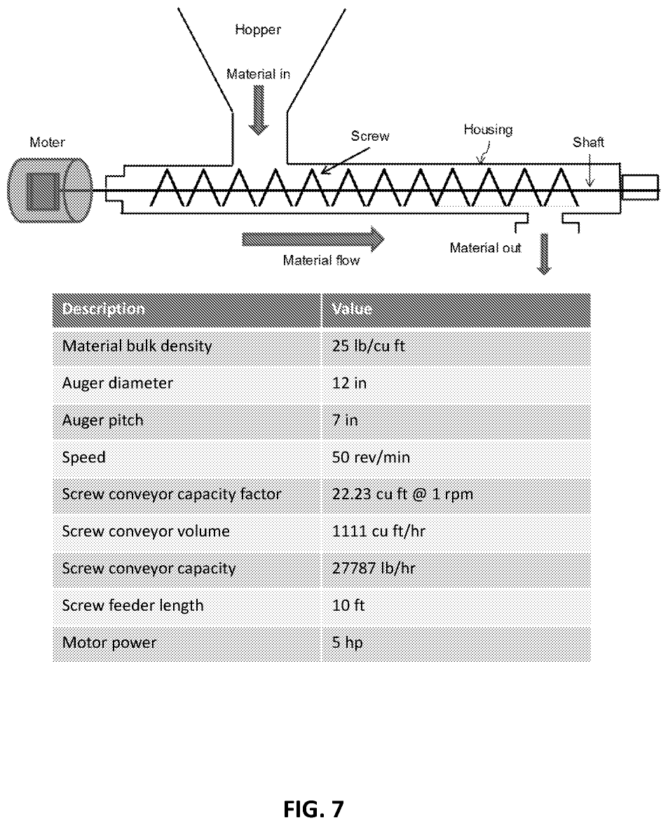

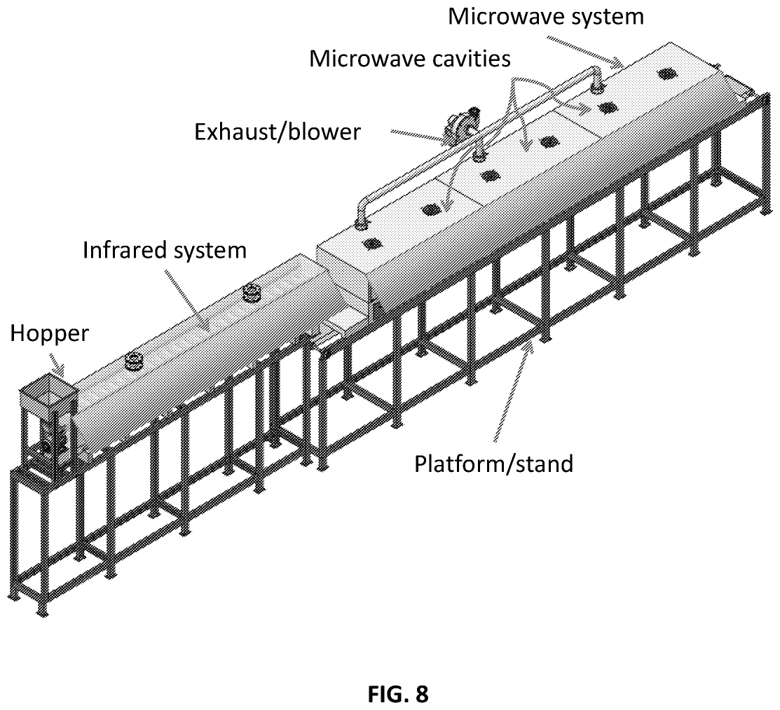

Also described herein are apparatuses wherein the first conveyor is operably linked to a fourth conveyor. In some embodiments, the fourth conveyor conveys the solid manure through the hopper and provides the solid manure to the first conveyor. In certain embodiments, the fourth conveyor is a screw conveyor. FIG. 7 describes a specific embodiment of the fourth conveyor and provides examples of approximate material bulk density, auger diameter, auger pitch, belt speed, screw conveyor capacity factor, screw conveyor volume, screw conveyor capacity, screw feeder length and motor power. In certain embodiments, the auger diameter is from about 6 to about 8 inches, or alternatively from about 8 to about 10 inches, or alternatively from about 10 to about 12 inches, or alternatively from about 12 to about 14 inches, or alternatively from about 14 to about 16 inches, or alternatively from about 16 to about 20 inches, or alternatively from about 20 to about 25 inches, or alternatively from about 25 to about 30 inches. In other embodiments, the auger pitch is from about 3 to about 5 inches, or alternatively from about 5 to about 7 inches, or alternatively from about 7 to about 10 inches, or alternatively from about 10 to about 15 inches, or alternatively from about 15 to about 20 inches, or alternatively from about 20 to about 25 inches.

In other embodiments, the screw feeder length is from about 5 to about 10 feet, or alternatively from about 10 to about 15 feet, or alternatively from about 15 to about 20 feet, or alternatively from about 20 to about 25 feet, or alternatively from about 25 to about 30 feet, or alternatively from about 30 to about 35 feet, or alternatively from about 35 to about 40 feet, or alternatively from about 40 to about 45 feet, or alternatively from about 45 to about 50 feet. The motor power of the screw conveyor can be from about 1 to about 5 hp, or alternatively from about 5 to about 10 hp, or alternatively from about 10 to about 15 hp, or alternatively from about 15 to about 20 hp, or alternatively from about 20 to about 25 hp, or alternatively from about 25 to about 30 hp, or alternatively from about 35 to about 40 hp, or alternatively from about 40 to about 45 hp, or alternatively from about 45 to about 50 hp.

Solid manure and/or flush manure may be obtained from agricultural operations, non-limiting examples of which include cattle farm or dairy barn, pig farm, chicken, turkey, duck or other poultry barn, horse stable, sheep or goat farm, from a zoo, or other source of large quantities of manure.

In some embodiments, the conveying is continuous. In certain embodiments, the conveying is discontinuous. In some embodiments, the speed at which the conveyor operates during the microwave or infrared radiation exposure is from about 50 to about 200 feet per minute, or alternatively from about 20 to about 30 feet per minute, or alternatively from about 30 to about 40 feet per minute, or alternatively from about 40 to about 50 feet per minute, or alternatively from about 50 to about 60 feet per minute, or alternatively from about 60 to about 70 feet per minute, or alternatively from about 70 to about 80 feet per minute, or alternatively from about 80 to about 90 feet per minute, or alternatively from about 90 to about 100 feet per minute, or alternatively from about 100 to about 110 feet per minute, or alternatively from about 110 to about 120 feet per minute, or alternatively from about 120 to about 130 feet per minute, or alternatively from about 130 to about 140 feet per minute, or alternatively from about 140 to about 150 feet per minute, or alternatively from about 150 to about 160 feet per minute, or alternatively from about 160 to about 170 feet per minute, or alternatively from about 170 to about 180 feet per minute, or alternatively from about 180 to about 190 feet per minute, or alternatively from about 190 to about 200 feet per minute, or alternatively from about 200 to about 210 feet per minute, or alternatively from about 210 to about 220 feet per minute, or alternatively from about 220 to about 230 feet per minute, or alternatively from about 230 to about 240 feet per minute, or alternatively from about 240 to about 250 feet per minute. In certain embodiments, the speed of the manure on the conveyors during their exposure to microwave or infrared radiation is the belt speed shown in FIG. 13.

The width of the conveyors can be from about 15 to about 17.5 inches, or alternatively from about 17.5 to about 20 inches, or alternatively from about 20 to about 22.5 inches, or alternatively from about 22.5 to about 24 inches, or alternatively from about 24 to about 25 inches, or alternatively from about 25 to about 27.5 inches, or alternatively from about 27.5 to about 30 inches, or alternatively from about 30 to about 32.5 inches, or alternatively from about 32.5 to about 35 inches, or alternatively from about 35 to about 37.5 inches, or alternatively from about 37.5 to about 40 inches. In one particular embodiment, the width of the conveyors is about 24 inches.

In other embodiments, the length of the conveyors is from about 5 to about 10 feet, or alternatively from about 10 to about 15 feet, or alternatively from about 15 to about 20 feet, or alternatively from about 20 to about 25 feet, or alternatively from about 25 to about 30 feet, or alternatively from about 30 to about 35 feet, or alternatively from about 35 to about 40 feet, or alternatively from about 40 to about 45 feet, or alternatively from about 45 to about 50 feet, or alternatively from about 50 to about 60 feet, or alternatively from about 60 to about 70 feet, or alternatively from about 70 to about 80 feet, or alternatively from about 80 to about 90 feet, or alternatively from about 90 to about 100 feet.

Non-limiting examples of conveyors that can be used include roller-belt conveyor such as those described in U.S. Pat. No. 7,249,671, accumulator conveyors such as those described in U.S. Pat. No. 7,063,206, loading conveyors such as those described in U.S. Pat. No. 2,721,645, singulating conveyors such as those described in U.S. Pat. No. 6,758,323, and feed conveyors such as those described in U.S. Pat. Nos. 4,715,593 and 5,234,094. Agricultural conveyors may also be used. Non-limiting examples of agricultural conveyors are provided in U.S. Pat. Nos. 10,375,889, 5,722,888 and 4,653,632, and U.S. Application No. 20190152714. In some embodiments, the conveyors include a self-propelled chassis, wherein the front end of the conveyor is configured to be raised and lowered automatically. In other embodiments, the conveyors used include screw conveyors. Non-limiting examples of screw conveyors are described, e.g., in U.S. Pat. Nos. 3,212,624 and 6,035,546, the disclosures of which are incorporated herein in their entireties for all purposes.

In certain embodiments, the microwave source can deliver microwave radiation exposure from about 25 kW to about 35 kW, or alternatively from about 35 kW to about 45 kW, or alternatively from about 45 kW to about 55 kW, or alternatively from about 55 kW to about 65 kW, or alternatively from about 65 kW to about 75 kW, or alternatively from about 75 kW to about 85 kW, or alternatively from about 85 kW to about 95 kW, or alternatively from about 95 kW to about 105 kW, or alternatively from about 105 kW to about 115 kW, or alternatively from about 115 kW to about 125 kW. In a certain embodiment, the microwave radiation exposure is about 75 kW. The microwave radiation exposure delivered by the microwave radiation source can be for about 3 minutes to about 6 minutes, or alternatively from about 1 minute to about 2 minutes, or alternatively from about 2 minutes to about 3 minutes, or alternatively from about 3 minutes to about 4 minutes, or alternatively from about 4 minutes to about 5 minutes, or alternatively from about 5 minutes to about 6 minutes, or alternatively from about 6 minutes to about 9 minutes, or alternatively from about 9 minutes to about 12 minutes, or alternatively from about 12 minutes to about 15 minutes, or alternatively from about 15 minutes to about 18 minutes, or alternatively from about 18 minutes to about 21 minutes, or alternatively from about 21 minutes to about 24 minutes. In a specific embodiment, the microwave radiation exposure is for about 6 minutes. In a particular embodiment, the microwave radiation exposure is about 75 kW for about 6 minutes.

Further provided herein are apparatuses that include an infrared radiation source operably coupled to the first conveyor. In one aspect, the infrared radiation source is disposed between the solid manure separator and the microwave radiation source. In another aspect, the microwave radiation source is disposed between the solid manure separator and the infrared radiation source. It is generally known that infrared radiation is an electromagnetic radiation (EMR) with wavelengths from about 700 nanometers (frequency 430 THz), to 1 millimeter (300 GHz). In certain embodiments, the infrared radiation source can deliver infrared radiation exposure from about 30,000 to about 150,000 BTUH, or alternatively from about 10,000 to about 20,000 BTUH, or alternatively from about 20,000 to about 30,000 BTUH, or alternatively from about 30,000 to about 40,000 BTUH, or alternatively from about 40,000 to about 50,000 BTUH, or alternatively from about 50,000 to about 60,000 BTUH, or alternatively from about 60,000 to about 70,000 BTUH, or alternatively from about 70,000 to about 80,000 BTUH, or alternatively from about 80,000 to about 90,000 BTUH, or alternatively from about 90,000 to about 100,000 BTUH, or alternatively from about 100,000 to about 110,000 BTUH, or alternatively from 110,000 to about 120,000 BTUH, or alternatively from about 120,000 to about 130,000 BTUH, or alternatively from about 130,000 to about 140,000 BTUH, or alternatively from about 140,000 to about 150,000 BTUH, or alternatively from about 150,000 to about 160,000 BTUH, or alternatively from about 160,000 to about 170,000 BTUH, or alternatively from about 170,000 to about 180,000 BTUH, or alternatively from about 180,000 to about 190,000 BTUH, or alternatively from about 190,000 to about 200,000 BTUH.

The infrared radiation exposure delivered by the infrared radiation source can be from about 0.5 minutes to about 3 minutes, or alternatively from about 0.5 minutes to about 10 minutes, alternatively from about 0.1 minutes to about 0.25 minutes, alternatively from about 0.25 minutes to about 0.5 minutes, alternatively from about 0.5 minutes to about 0.75 minutes, alternatively from about 0.75 minutes to about 1 minutes, alternatively from about 1 minutes to about 1.5 minutes, alternatively from about 1.5 minutes to about 2 minutes, alternatively from about 2 minutes to about 2.5 minutes, alternatively from about 2.5 minutes to about 3 minutes, alternatively from about 3 minutes to about 6 minutes, or alternatively from about 1 minute to about 2 minutes, or alternatively from about 2 minutes to about 3 minutes, or alternatively from about 3 minutes to about 4 minutes, or alternatively from about 4 minutes to about 5 minutes, or alternatively from about 5 minutes to about 6 minutes, or alternatively from about 6 minutes to about 9 minutes, or alternatively from about 9 minutes to about 12 minutes, or alternatively from about 12 minutes to about 15 minutes, or alternatively from about 15 minutes to about 18 minutes, or alternatively from about 18 minutes to about 21 minutes, or alternatively from about 21 minutes to about 24 minutes.

Notwithstanding the appended claims, the present disclosure is further defined by the following embodiments:

1. A method of producing solid dry manure, comprising:
disposing solid manure on a first conveyor operably coupled to a microwave radiation source;
using the first conveyor, conveying the solid manure past the microwave radiation source; and
during the conveying, exposing the solid manure to microwave radiation emitted from the microwave radiation source to produce solid dry manure.
   2. The method according to embodiment 1, wherein the disposing comprises disposing solid manure on the first conveyor at an average thickness of from about 5 cm to about 100 cm.
   3. The method according to embodiment 1, wherein the disposing comprises disposing solid manure on the first conveyor at an average thickness in a range selected from the group consisting of: from about 10 cm to about 25 cm, from about 25 cm to about 50 cm, and from about 50 cm to about 75 cm.
   4. The method according to embodiment 1, wherein the disposing comprises disposing solid manure on the first conveyor at an average thickness in a range selected from the group consisting of: from about 5 cm to about 15 cm, from about 30 cm to about 40 cm, from about 50 cm to about 60 cm, and from about 65 cm to about 75 cm.
   5. The method according to any one of embodiments 1 to 4, wherein the exposing is for a duration of from about 6 to about 12 minutes.
   6. The method according to embodiment 5, wherein the exposing is for a duration of from about 7 to about 11 minutes.
   7. The method according to embodiment 6, wherein the exposing is for a duration of from about 8 to about 10 minutes.
   8. The method according to any one of embodiments 1 to 7, wherein the exposing produces solid dry manure comprising a pathogen content of 20% or less, 10% or less, 5% or less, 2.5% or less, or 0% as compared to the pathogen content of the solid manure disposed on the first conveyor.
   9. The method according to any one of embodiments 1 to 8, wherein the exposing produces solid dry manure comprising a moisture content of about 30% to about 45% as compared to the moisture content of the solid manure disposed on the first conveyor.
   10. The method according to embodiment 9, wherein the exposing produces solid dry manure comprising a moisture content of about 35% to about 40% as compared to the moisture content of the solid manure disposed on the first conveyor.
   11. The method according to any one of embodiments 1 to 10, wherein the solid manure is conveyed past the microwave radiation source at a speed of from 50 to 200 feet per minute.
   12. The method according to any one of embodiments 1 to 11, wherein the power of the microwave radiation emitted from the microwave radiation source is from about 1500 watts to about 1700 watts.
   13. The method according to any one of embodiments 1 to 12, wherein the first conveyor is further operably coupled to an infrared radiation source.
   14. The method according to embodiment 13, further comprising:
using the first conveyor, conveying the solid manure past the infrared radiation source; and
during the conveying, exposing the solid manure to infrared radiation emitted from the infrared radiation source.
   15. The method according to embodiment 14, wherein exposing the solid manure to the infrared radiation produces solid manure having a viable pathogen content that is reduced by 75% or more as compared to the solid manure prior to exposure to the infrared radiation.
   16. The method according to embodiment 14, wherein exposing the solid manure to the infrared radiation produces solid manure having a viable pathogen content that is reduced by 95% or more as compared to the solid manure prior to exposure to the infrared radiation.
   17. The method according to any one of embodiments 14 to 16, wherein the solid manure is exposed to the infrared radiation prior to the solid manure being exposed to the microwave radiation.
   18. The method according to any one of embodiments 14 to 16, comprising exposing the solid manure to the microwave radiation to produce the solid dry manure, and subsequently exposing the solid dry manure to the infrared radiation.
   19. The method according to any one of embodiments 1 to 18, wherein the conveying is continuous.
   20. The method according to any one of embodiments 1 to 18, wherein the conveying is discontinuous.
   21. The method according to any one of embodiments 1 to 20, further comprising, prior to disposing the solid manure on the first conveyor, separating the solid manure from flush manure.
   22. The method according to embodiment 21, wherein the solid manure is separated from flush manure using a solid manure separator operably coupled to the first conveyor.
   23. The method according to embodiment 22, wherein the solid manure separator is operably coupled to the first conveyor via a second conveyor.
   24. The method according to embodiment 23, wherein the second conveyor disposes the solid manure in a hopper operably coupled to the first conveyor.
   25. An apparatus for producing solid dry manure, comprising:

a solid manure separator operably coupled to a first conveyor; and

a microwave radiation source operably coupled to the first conveyor.

26. The apparatus of embodiment 25, wherein the solid manure separator is operably coupled to the first conveyor via a second conveyor.
27. The apparatus of embodiment 26, wherein the first conveyor is operably coupled to a hopper, and the second conveyor is configured to dispose solid manure into the hopper.
28. The apparatus of embodiment 27, wherein the second conveyer is inclined such that the inclined end of the second conveyor is disposed above the hopper.
29. The apparatus of any one of embodiments 25 to 28, further comprising an infrared radiation source operably coupled to the first conveyor.
30. The apparatus of embodiment 29, wherein the infrared radiation source is disposed between the solid manure separator and the microwave radiation source.
31. The apparatus of embodiment 29, wherein the microwave radiation source is disposed between the solid manure separator and the infrared radiation source.
32. The apparatus of any one of embodiments 25 to 31, wherein the first conveyor is operably coupled to a third conveyor.
33. The apparatus of embodiment 32, wherein the third conveyor is inclined, the lower portion of the third conveyor is operably coupled to a feeder, and the first conveyor is configured to dispose solid dry manure produced using the microwave radiation source into the feeder.

The following examples are offered by way of illustration and not by way of limitation.

### EXPERIMENTAL

### Example 1—Microwave Treatment of Cow Manure

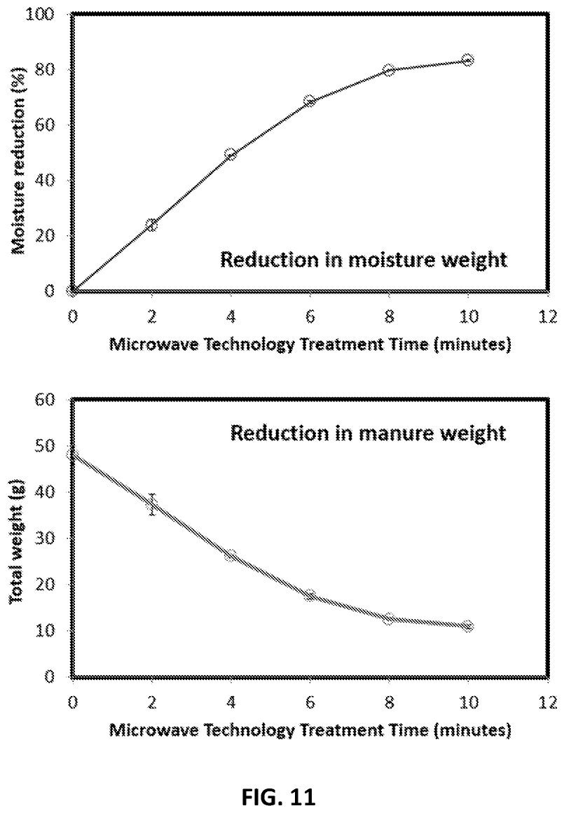

The solid cow manure was subjected to 1.250 kW microwave radiation for the following time periods (in minutes): 2, 4, 6, 8 and 10 (FIG. 11). Thickness of the solid manure was approximately 1.5 inches. The reduction in moisture weight and total manure weight of the solid manure after being irradiated with microwave radiation was calculated by monitoring and noting the differences in moisture at each interval. A formulation published by American Public Health Association was used to calculate moisture content. The solid dry cow manure showed over 80% reduction in moisture weight and total manure weight after being exposed to microwave radiation for 10 minutes.

### Example 2—Drying Rate and Drying Time Post-Microwave Treatment of Cow Manure

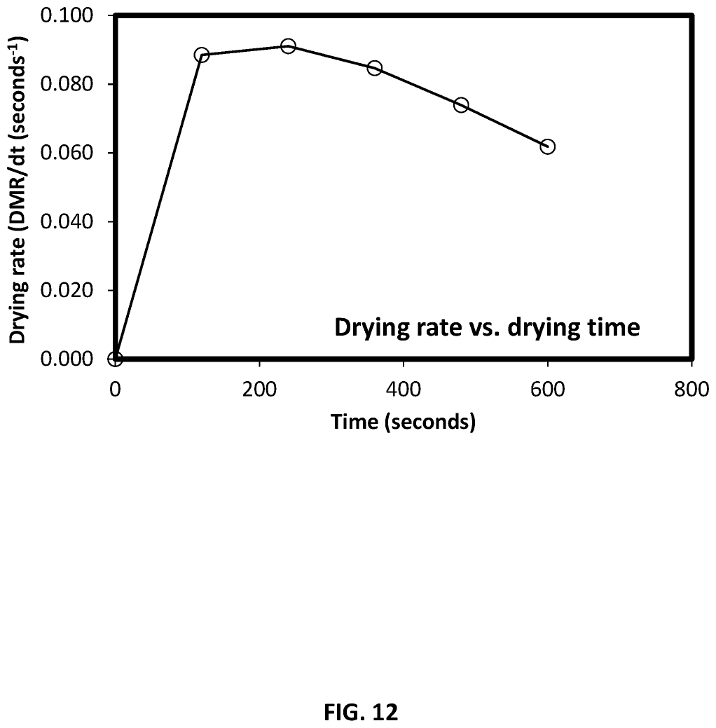

The solid cow manure was subjected to 1.250 kW microwave radiation and the drying rate and drying time of the solid cow manure was plotted (FIG. 12). Thickness of the solid manure was approximately 1.5 inches.

### Example 3—Microwave Treatment of Cow Manure: Belt Speed and Belt Length

The solid cow manure was deposited on a conveyor belt and subjected to 1.250 kW microwave radiation and the belt speed and belt length subjected to microwave treatment was plotted (FIG. 13). Using the exposure time of manure to microwave in batch mode, the belt speed was calculated by simply taking the ratio between belt length and exposure time. This method facilitated calculating the exposure time, belt speed, and belt length for continuous system where manure will be moving continuously on conveyor belt. Thickness of the solid manure was approximately 1-2 inches on the conveyor belt.

### Example 4—Microwave Treatment of Cow Manure: Temperature

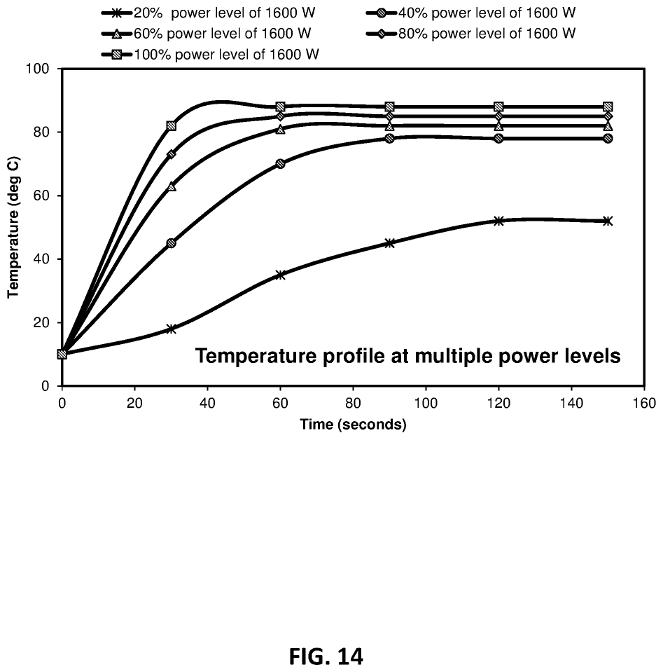

The solid cow manure was subjected to 20%, 40%, 60%, 80% or 100% of 1.650 kW microwave radiation for 30, 60, 90, 120 and 150 seconds. Temperature of the manure was monitored at each interval of time and plotted (FIG. 14). Thickness of the manure was approximately 1.5 inches. FIG. 14 shows that the manure temperature can reach up to approximately 80° C. when subjected to 1.650 kW microwave radiation for 30 seconds. High temperatures such as 80° C. kill all pathogens in the manure. For additional moisture removal, the manure can be exposed to microwave radiation from about 5 minutes to about 10 minutes.

### Example 5—Microwave Treatment of Cow Manure: Temperature, Pathogen Content and Moisture Content

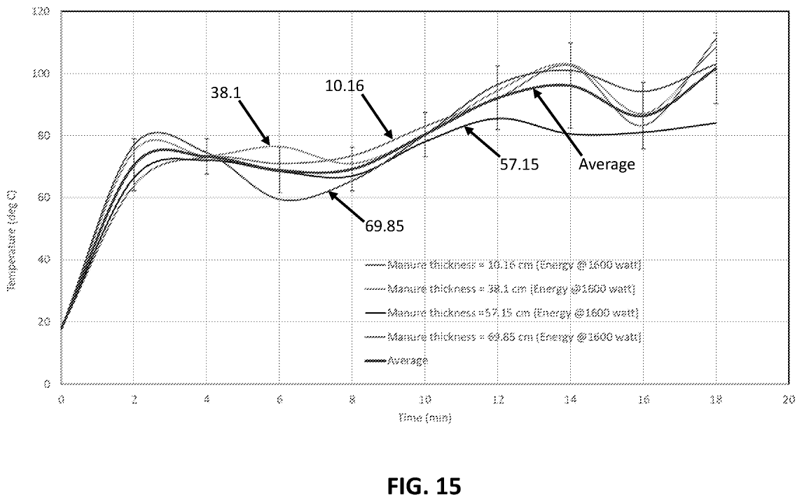

Solid manure of various average thicknesses ranging from 10.16 cm, 38.1 cm, 57.15 cm, to 69.85 cm were provided on a conveyor system and exposed to microwave treatment using a 1600 watt microwave source (120 V and 60 Hz) for the following time periods: 0 min, 2 min, 4 min, 6 min, 8 min, 10, min, 12 min, 14 min, 16 min, and 18 min. The solid manure temperature profile was monitored at each time period to determine the temperature increments. Result are shown in FIG. 15.

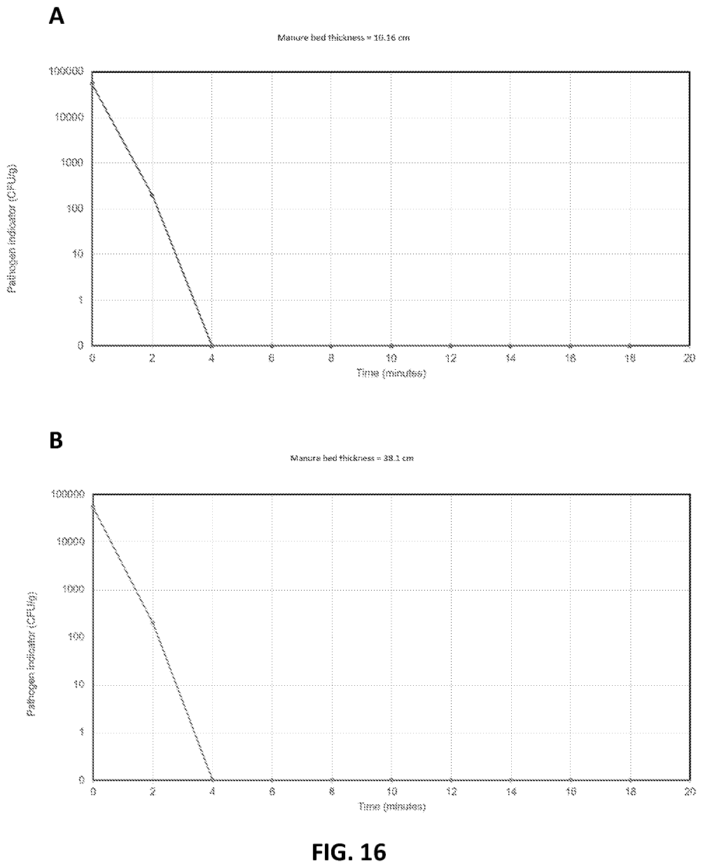

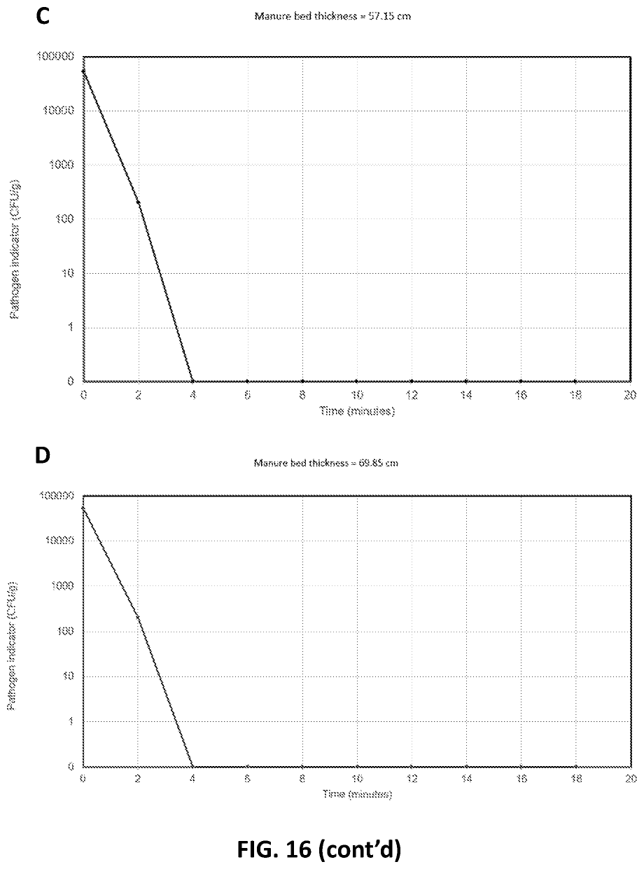

In addition to temperature profiles, the pathogen content (E. coli) profiles of the solid manure of the various average thicknesses were monitored. Results are shown in FIG. 16.

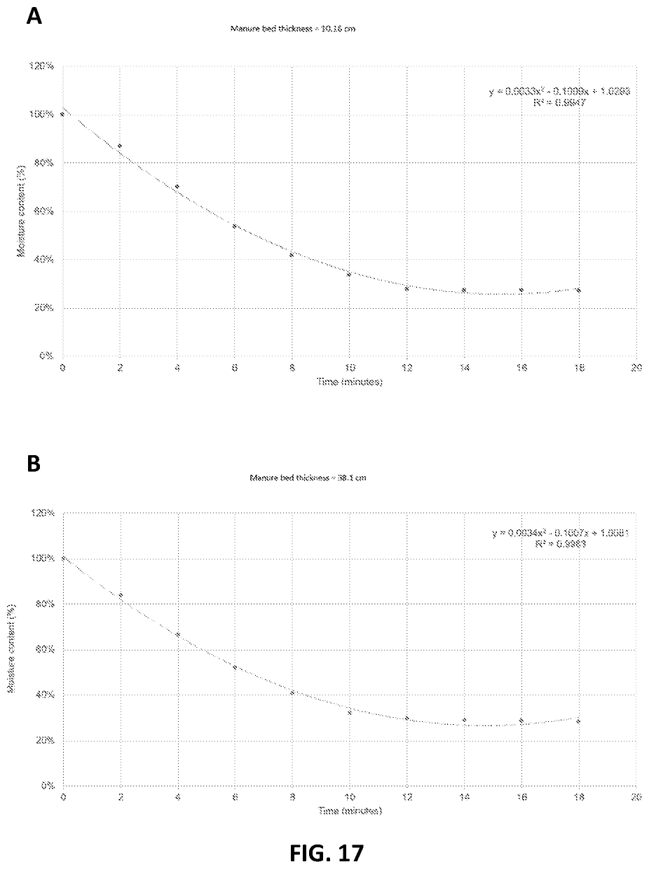

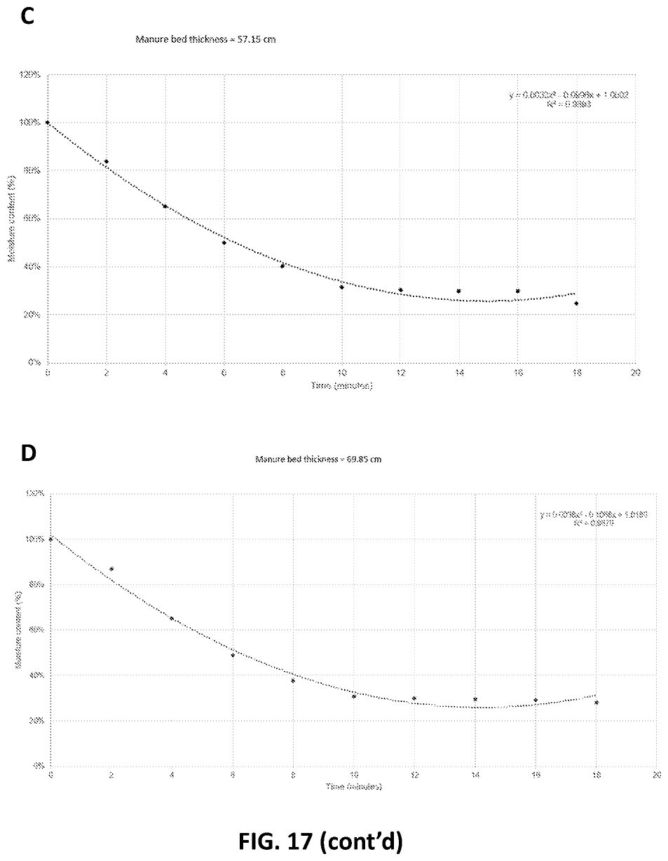

In addition to temperature and pathogen content profiles, the moisture content profiles of the solid manure of the various average thicknesses were monitored. Results are shown in FIG. 17.

Accordingly, the preceding merely illustrates the principles of the present disclosure. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein.

What is claimed is:

1. A method of producing solid dry manure, comprising:
disposing solid manure on a first conveyor operably coupled to a microwave radiation source;
using the first conveyor, conveying the solid manure past the microwave radiation source; and
during the conveying, exposing the solid manure to microwave radiation emitted from the microwave radiation source to produce solid dry manure.

2. The method according to claim 1, wherein the disposing comprises disposing solid manure on the first conveyor at an average thickness of from about 5 cm to about 100 cm.

3. The method according to claim 1, wherein the disposing comprises disposing solid manure on the first conveyor at an average thickness in a range selected from the group consisting of: from about 10 cm to about 25 cm, from about 25 cm to about 50 cm, and from about 50 cm to about 75 cm.

4. The method according to claim 1, wherein the disposing comprises disposing solid manure on the first conveyor at an average thickness in a range selected from the group consisting of: from about 5 cm to about 15 cm, from about 30 cm to about 40 cm, from about 50 cm to about 60 cm, and from about 65 cm to about 75 cm.

5. The method according to any one of claims 1 to 4, wherein the exposing is for a duration of from about 6 to about 12 minutes.

6. The method according to claim 5, wherein the exposing is for a duration of from about 7 to about 11 minutes.

7. The method according to claim 6, wherein the exposing is for a duration of from about 8 to about 10 minutes.

8. The method according to any one of claims 1 to 7, wherein the exposing produces solid dry manure comprising a pathogen content of 20% or less, 10% or less, 5% or less, 2.5% or less, or 0% as compared to the pathogen content of the solid manure disposed on the first conveyor.

9. The method according to any one of claims 1 to 8, wherein the exposing produces solid dry manure comprising a moisture content of about 30% to about 45% as compared to the moisture content of the solid manure disposed on the first conveyor.

10. The method according to claim 9, wherein the exposing produces solid dry manure comprising a moisture content of about 35% to about 40% as compared to the moisture content of the solid manure disposed on the first conveyor.

11. The method according to any one of claims 1 to 10, wherein the solid manure is conveyed past the microwave radiation source at a speed of from 50 to 200 feet per minute.

12. The method according to any one of claims 1 to 11, wherein the power of the microwave radiation emitted from the microwave radiation source is from about 1500 watts to about 1700 watts.

13. The method according to any one of claims 1 to 12, wherein the first conveyor is further operably coupled to an infrared radiation source.

14. The method according to claim 13, further comprising:
using the first conveyor, conveying the solid manure past the infrared radiation source; and
during the conveying, exposing the solid manure to infrared radiation emitted from the infrared radiation source.

15. The method according to claim 14, wherein exposing the solid manure to the infrared radiation produces solid manure having a viable pathogen content that is reduced by 75% or more as compared to the solid manure prior to exposure to the infrared radiation.

16. The method according to claim 14, wherein exposing the solid manure to the infrared radiation produces solid manure having a viable pathogen content that is reduced by 95% or more as compared to the solid manure prior to exposure to the infrared radiation.

17. The method according to any one of claims 14 to 16, wherein the solid manure is exposed to the infrared radiation prior to the solid manure being exposed to the microwave radiation.

18. The method according to any one of claims 14 to 16, comprising exposing the solid manure to the microwave radiation to produce the solid dry manure, and subsequently exposing the solid dry manure to the infrared radiation.

19. The method according to any one of claims 1 to 18, wherein the conveying is continuous.

20. The method according to any one of claims 1 to 18, wherein the conveying is discontinuous.

21. The method according to any one of claims 1 to 20, further comprising, prior to disposing the solid manure on the first conveyor, separating the solid manure from flush manure.

22. The method according to claim 21, wherein the solid manure is separated from flush manure using a solid manure separator operably coupled to the first conveyor.

23. The method according to claim 22, wherein the solid manure separator is operably coupled to the first conveyor via a second conveyor.

24. The method according to claim 23, wherein the second conveyor disposes the solid manure in a hopper operably coupled to the first conveyor.

25. An apparatus for producing solid dry manure, comprising:
a solid manure separator operably coupled to a first conveyor; and
a microwave radiation source operably coupled to the first conveyor.

26. The apparatus of claim 25, wherein the solid manure separator is operably coupled to the first conveyor via a second conveyor.

27. The apparatus of claim 26, wherein the first conveyor is operably coupled to a hopper, and the second conveyor is configured to dispose solid manure into the hopper.

28. The apparatus of claim 27, wherein the second conveyer is inclined such that the inclined end of the second conveyor is disposed above the hopper.

29. The apparatus of any one of claims 25 to 28, further comprising an infrared radiation source operably coupled to the first conveyor.

30. The apparatus of claim 29, wherein the infrared radiation source is disposed between the solid manure separator and the microwave radiation source.

31. The apparatus of claim 29, wherein the microwave radiation source is disposed between the solid manure separator and the infrared radiation source.

32. The apparatus of any one of claims 25 to 31, wherein the first conveyor is operably coupled to a third conveyor.

33. The apparatus of claim 32, wherein the third conveyor is inclined, the lower portion of the third conveyor is operably coupled to a feeder, and the first conveyor is configured to dispose solid dry manure produced using the microwave radiation source into the feeder.
